(19) United States
(12) Patent Application Publication
(10) Pub. No.: US 2015/0005950 A1
(43) Pub. Date: Jan. 1, 2015

(54) System and method for food processing and preparation by cooking and computer programme implementing the method

(71) Applicant: COMPAÑIA ESPAÑOLA DE ELECTROMENAJE S.A., Oliana (Lleida) (ES)

(72) Inventors: Lluís Trench Roca, Sallent (Barcelona) (ES); Josep Alet Vidal, Oliana (LLEIDA) (ES); Fidel Montraveta Montraveta, Oliana (LLEIDA) (ES)

(73) Assignee: COMPAÑIA ESPAÑOLA DE ELECTROMENAJE S.A., Oliana (Lleida) (ES)

(21) Appl. No.: 14/307,779

(22) Filed: Jun. 18, 2014

(30) Foreign Application Priority Data
Jul. 1, 2013 (EP) 13380027

(51) Int. Cl. G05B 11/01; A47J 27/00

(52) U.S. Cl. CPC G05B 11/01; A47J 27/00
USPC 700/275; 99/342

(57) ABSTRACT

The system includes at least one cooking appliance controlled from remote control means through a bidirectional communications network comprising an intermediate server with the capacity to process and transmit at least control instructions from said remote control means to a microprocessor of local control means, or vice versa.

The proposed method is adapted to be carried out using the system proposed by the invention.

The computer programme embodies one part of the proposed method.

### FIELD OF THE ART

The present invention relates, in general, in a first aspect, to a system for food processing and preparation by cooking including at least one cooking appliance controlled from remote control means, through a bidirectional communications network, and, more particularly, to a system comprising an intermediate server that processes and transmits instructions for the control of the appliance.

A second aspect of the invention relates, in general, to a method for food processing and preparation by cooking comprising remotely controlling a cooking appliance through a bidirectional communications network, and, more particularly, to a method comprising processing and transmitting instructions, asynchronously or synchronously, for the control of the appliance by means of an intermediate server.

A third aspect of the invention relates to a computer programme embodying a part of the method of the second aspect.

### STATE OF THE PRIOR ART

From patent documents U.S. Pat. No. 5,363,746 A, U.S. Pat. No. 6,565,903 B2, EP 1561409 B1 and US2013003490A1 systems and methods are known for food processing and preparation by cooking that include remote control means of such appliances wherein the control, in some cases, is carried out by establishing a communications network (such as a mobile telephony network or the Internet) between the remote control means and a corresponding local unit of the appliance itself.

None of said patent documents teach or suggest the provision, within the established communications networks, of an intermediate server for handling said remote control of the appliance, so that all operations are always carried out through said intermediate server and, as a result, without at any time there being either a direct connection between the cooking appliance and the machine/device, or the possibility of controlling several appliances, or of using some components of the proposed systems by several users or from several remote computing devices.

### DISCLOSURE OF THE INVENTION

It appears necessary to offering an alternative to the state of the art that will overcome the shortcomings found therein and that, as a result, will permit attaining a safer and more elaborate control of one o several cooking appliances in a remote manner.

With such an end, the present invention relates, in a first aspect, to a system for food processing and preparation by cooking that comprises, in a way known per se:
a cooking appliance for food processing and preparation by cooking integrating local control means including at least one microprocessor for the control of the power supply and the operation of actuation means and thermal energy transfer means of said appliance, based on control instructions containing at least some cooking parameters and communications means in connection with said microprocessor, and
remote control means including an independent user computing device (such as a smartphone, a PDA, a tablet computer or a personal computer, among others) separate from said appliance constituting an external user interface for at least the entry of said control instructions and comprising communications means through which the user computing device is in communication with the wireless communications means of said local control means through a communications network, at least for forwarding said control instructions to the microprocessor, said communications network being full duplex and comprising an intermediate server that processes and transmits at least said control instructions, generally by means of communications protocols, whether synchronously or asynchronously, from remote control means, to the microprocessor of the local control means, or vice versa.

Unlike the state-of-the-art systems, in the one proposed by the first aspect of the present invention said food processing and preparation cooking appliance (A1) is a first appliance, and the system further includes: a plurality of food processing and preparation cooking appliances (A1, A2), including said first appliance (A1), each of them with local control means identical or similar to those of the first appliance (A1); and integrates a database (B) comprised and/or accessible by said intermediate server (S), comprising data relative to said plurality of cooking appliances (A1, A2), indicating their current state and their operational history, and to a plurality of users, including at least respective identification information thereof and the association between users and groups of cooking appliances (A1, A2).

Preferably, at least part of the communications network is wireless (in general, by radio access). The latter can be wireless either fully or only in part, including hardwired portions, for instance of optical fibre.

For one preferred embodiment, the intermediate server is a cloud-like computing infrastructure, or part thereof, and it is formed by one single computing entity or by a plurality of computing entities cooperating with one another.

The communications network is preferably a wide area network, although for other embodiments, the network is of a different type, such as a medium area network, or a combination of different types of network.

According to one embodiment, said user computing device is a first device, and the system comprises a plurality of user computing devices, including the first device, with respective communications means in communication with said communications network, each of them being controllable by at least one user and implementing a respective external user interface for the entry of control instructions for controlling one or more food processing and preparation cooking appliances.

According to one preferred embodiment, the intermediate server makes the forwarding of said control instructions to the microprocessor of the required appliance conditional on the result of at least cross-checking user's identification information of the user computing device and of the appliance he or she wishes to control. This way, an important aspect of this invention's proposal appears, offering security conditions for the remote operation of a cooking appliance by interposing a verification control unit of the characteristics and conditions of the system users.

Optionally, the intermediate server also makes the forwarding of said control instructions to the microprocessor of the required appliance conditional on the result of a verification of the operational state of the appliance and/or of a verification of the existence of some type of error occurred in the appliance.

Advantageously, the appliances of said plurality of food processing and preparation cooking appliances are grouped together forming different groups, each group being associated with one or more users for its control by means of the corresponding forwarding of control instructions to the microprocessors of its local control means, which control the devices of their respective groups by means of one or more computing devices that will allow their communication with an intermediate server whereat the user will identify himself or herself, as well as the appliance he or she wishes to control, the intermediate server authorising him or her, or failing to do so, based on the result of cross-checking identifications, which allows to know if the user in question is associated with the appliance he or she wishes to control.

The server acquires the information recorded in said database for carrying out the validations described above, and also for incorporating new information resulting from the system operation and/or new records of users and appliances, so as to update the database.

Each of the users utilising the system has access, according to one embodiment, by means of one or more user computing devices, and conditional on the authentication carried out by the intermediate server, to at least part of the information recorded in said database and/or received by the intermediate server from the microprocessor of a cooking appliance associated with the user in question, including a signal confirming the reception of a control instruction that will let the user know that the control instructions he or she has sent to the intermediate server so as to control an appliance have been received by the intermediate server and/or by the required appliance.

The cooking parameters may advantageously include the different steps of a recipe, it being possible to create or generate a library comprising different recipes. In addition, these recipes may also be updated and/or shared among different users through different social networks or through a blog.

According to one embodiment, the control instructions include identification information of the appliance that is to be controlled and/or of the user that is utilising the user computing device from which he or she wishes to control the appliance. For one further alternative embodiment, such identification information is not included in the control instructions; rather, it is forwarded to the intermediate server, or acquired by it, by other means.

In general, the user accesses the service provided by the intermediate server, that is, the control of one or more cooking appliances, upon logging into it, for instance through a specific application (‘App’) installed in his or her device or through a web page, said record including the identification of the cooking appliances belonging to him or her or whose control is granted to him or her.

Once logged in, the user can automatically control the appliance or appliances associated with him or her, directly sending one or more control instructions to the intermediate server, for instance through said application or another specific application or through said web page or another web page, whether it be after automatically carrying out the identification/authentication—for instance, by running said application—or after a manual identification/authentication, by entering a username and password required by the intermediate server in a home page of said application or said web page.

Additionally or alternatively to said user identification/authentication by the intermediate server, according to one embodiment, the identification/authentication of the user computing devices from which the service is requested is carried out.

A second aspect of the invention concerns a method for food processing and preparation by cooking comprising, in a way known per se, the control of a cooking appliance for food processing and preparation by cooking, based on control instructions containing at least some cooking parameters, forwarded to local control means of the appliance, through a communications network, from remote control means including an independent user computing device separate from the appliance; and the processing and transmitting, through an intermediate server of the communications network, said control instructions, which may be encrypted by means of cryptographic protocols so as to provide a safer transmission through said communications network from the remote control means to the local control means, or vice versa.

Unlike the known state-of-the-art methods, the method proposed by the second aspect of the present invention controlling a plurality of cooking appliances by one or more users, from one or more user computing devices through the supervision and control of the asynchronous or synchronous forwarding of control instructions, from the respective remote control means, to the local control means of the required appliance by means of the intermediate server of the communications network.

Preferably, the method comprises carrying out, by the intermediate server, the forwarding of control instructions to the local control means of the required appliance conditional on the result of at least cross-checking user's identification information of the user of the user computing device and of the appliance he or she wishes to control, carried out by the intermediate server.

Optionally, the method of the second aspect of the invention further comprises making the forwarding of the control instructions to the microprocessor of the required appliance conditional on the result of a verification of the operational state of the appliance and/or of a verification of the existence of some type of error occurred in the appliance, carried out by the intermediate server.

For one embodiment, the method comprises the forwarding, by the intermediate server, of a signal confirming the reception of a control instruction to the user computing device from which a user has requested the control of a cooking appliance, by the intermediate server and/or the appliance to be controlled.

The intermediate server preferably acquires, either actively or passively, said identification (such as serial numbers) and state information of the appliance or appliances through the communications means of the local control means and at least user identification information (such as a nickname or a username) through the communications means of the user computing device or devices.

The method proposed by the second aspect of the invention is adapted to be carried out using the system proposed by the first aspect of the invention, and vice versa (i.e., the system is adapted to implement the method). Let the embodiments described above in connection with the operation of the system proposed by the first aspect of the invention serve as descriptive embodiments of the possible actions or steps to be carried out through the method proposed by the second aspect of the invention, including said authentications, records in the service provided by the intermediate server, etc.

It has further been envisaged that said intermediate server may also further transmit multimedia information, e.g. of an advertising or formative type, which will be shown on said user computing device in said user interface or screen thereof, based on the data acquired of the operation throughout time by the appliance user.

A third aspect of the present invention concerns a computer programme including coded instructions that, when run in a computer, implement the method of the second aspect for conditionally forwarding the control instructions to the local control means of the appliance required, as explained above.

The computer programme comprises respective software applications: a first software application, executable by the user computing device, such as the aforementioned specific application (‘App’), to carry out at least the operations described above associated with the user computing device, showing (once executed) graphical information on the user computing device screen in the form, for instance, of different menus or options for controlling the appliances associated with one or more users in order to build said external user interface, and a second software application executable by the intermediate server to carry out at least the actions described above relative thereto (validations, authentication, forwarding of control instructions to the device, acknowledgements to the user computing device, etc.).

According to one embodiment, the first software application lets the user carry out the selection of the cooking appliance to be controlled, as well as the desired control instructions and/or control parameters (start/end time, cooking duration, temperature, speed of the actuation means, etc.), whether individually, directly, or as a group, indirectly and in an advantageously transparent manner, for instance by selecting a recipe to be implemented by the cooking appliance that has a series of values associated for the control parameters that are sent to the intermediate server, without their necessarily being shown in detail to the user.

### BRIEF DESCRIPTION OF THE DRAWINGS

The above and other advantages and characteristics will be more fully understood from the following detailed description of embodiments with reference to the attached drawings, which must be taken by way of illustration, not limitation, wherein:

FIG. 1 diagrammatically shows one embodiment of the system proposed by the first aspect of the invention, for which the latter comprises a cooking appliance, a user computing device and an intermediate server, formed and integrated in a cloud-like computing infrastructure of a communications network to which both the cooking appliance and the user computing device are connected;

FIG. 2 shows one further embodiment of the system proposed by the first aspect of the invention that differs from the one in FIG. 1 in that it includes two cooking appliances to be controlled from one user's computing device, which is illustrated, and wherein the cloud-like intermediate server includes a database; and

FIG. 3 shows one additional further embodiment of the system proposed by the first aspect of the invention that differs from the one in FIG. 2 in that it includes several user computing devices from which the illustrated cooking appliances are controlled.

### DETAILED DESCRIPTION OF SOME EMBODIMENTS

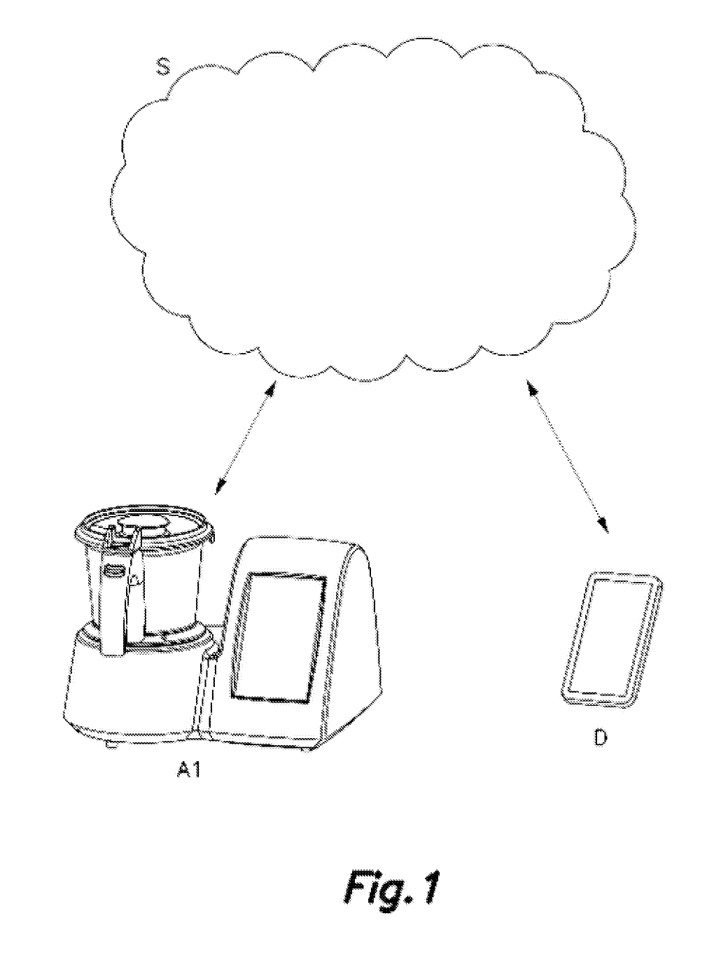

As illustrated in FIGS. 1, 2 and 3, the system for food processing and preparation by cooking proposed by the first aspect of the invention comprises:
one or more cooking appliances A1, A2 for food processing and preparation by cooking comprising local control means (internal to the illustrated appliance or appliances) including at least one microprocessor for the control of the power supply and the operation of actuation means and thermal energy transfer means of each of said appliances A1, A2 based on control instructions containing at least some cooking parameters and communications means, which, in these particular embodiments, are wireless, in connection with said microprocessor, and
remote control means including one or more independent user computing devices D1, D2, D3 separate from the appliance or appliances A1, A2 constituting an external user interface for at least the entry of control instructions and comprising wireless communications means (internal to the illustrated device) through which the user computing device D1, D2, D3 is in communication with the wireless communications means of said local control means through a communications network at least, among others, for forwarding the control instructions to the microprocessor.

According to the proposal of the present invention, said communications network comprises an intermediate server S that supervises and controls the asynchronous or synchronous forwarding of control instructions, in an asynchronous or synchronous way, depending on the communications protocol used, from the remote control means to the microprocessor of the local control means.

In addition, according to one preferred embodiment, said intermediate server S is conceived, among other functions, to make the forwarding of said control instructions to the microprocessor of the required appliance A1, A2 conditional on the result of at least cross-checking at least user's identification information of the user of of the user computing device D1, D2, D3 and of the appliance A1, A2 he or she wishes to control. Alternatively, the intermediate server S may even make said forwarding conditional on the result of a verification of the operational state of the appliance and/or of a verification of the existence of some type of error occurred in the appliance.

This way, said intermediate server S intervenes in all communications between user computing devices and the appliance or appliances A1, A2, processing and transmitting all the instructions and contributing a security component in any operations.

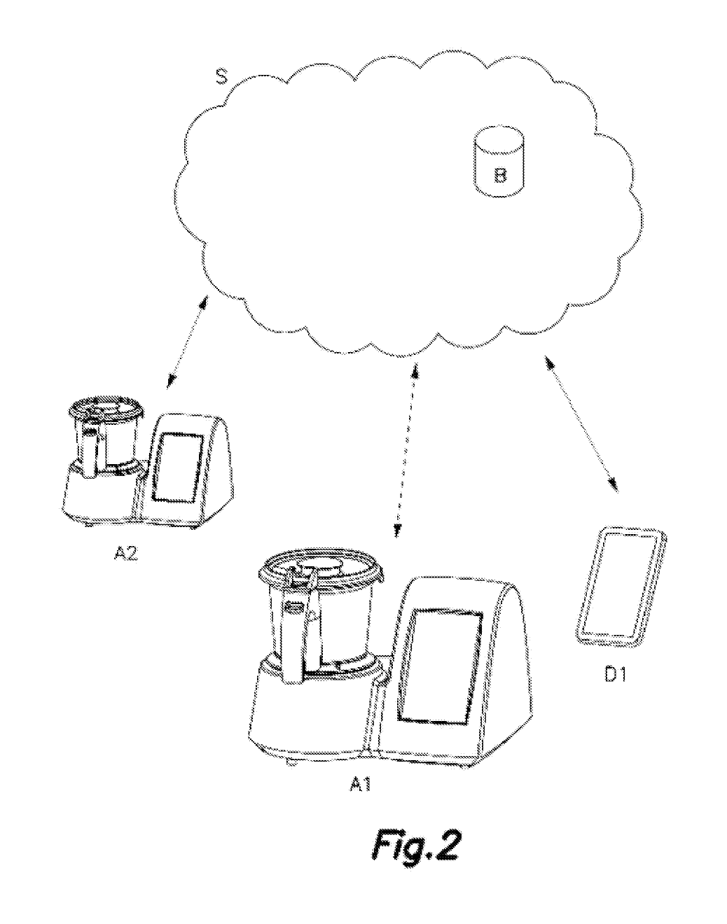

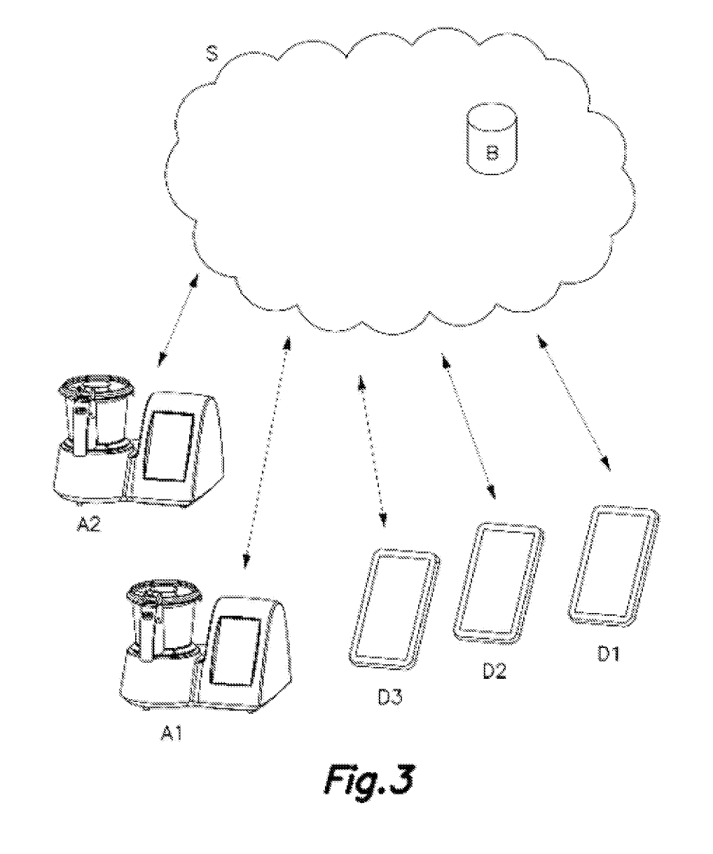

FIGS. 2 and 3 show embodiments wherein the system includes a database B that may comprise and/or be accessible by said intermediate server S. Generally, this database will include data relative to said appliances A1, A2 and data relative to the different users. Said data that will be included in said database B may include information relative to user registrations, cancellations or data maintenance; information relative to registrations, cancellations or data maintenance for the appliance(s) registered for one user; a control time for the users' logins/logouts; information relative to the time of operation of each of the registered appliances; information regarding recipes published by one user and other users; private information of each user (for instance, for preparing and archiving one's own recipes, storing photos, notes, etc.); information relative to a user's connectivity with different social networks; a record of the recipes resorted to by a user, etc.

In addition, advantageously and according to an improvement of the present invention, the database B may also include a mechanism that will allow offering each user, through the respective user's computing device, a recipe schedule within a time frame—for instance for one entire week—, depending on the user's preferences (for instance, among others, low-calorie, vegetarian or regional recipes). It may even include a mechanism offering each user recipes with food ingredients that said user has in stock, thereby preventing the wastage of foodstuffs by the user.

In these embodiments, each of said users, by means of their respective computing devices D1, D2, D3, may access, generally conditional on the authentication carried out by the intermediate server S, to at least part of the information recorded in said database B and/or received by the intermediate server S from the microprocessor of a cooking appliance A1, A2 associated with said user, including a signal confirming the reception of a control instruction.

The scope of the present invention is defined in the following attached claims.

1. A system for food processing and preparation by cooking comprising:
a cooking appliance (A1) for food processing and preparation by cooking comprising local control means including at least one microprocessor for the control of the power supply and the operation of actuation means and thermal energy transfer means of said appliance (A1), based on control instructions containing at least some cooking parameters and communications means in connection with said microprocessor, and
remote control means including an independent user computing device (D1) separate from said appliance (A1) constituting an external user interface for at least the entry of said control instructions and comprising communications means of the user computing device (D1) for communicating with said local control means through a communications network at least for forwarding said control instructions to the microprocessor, wherein said communications network is bidirectional and comprises an intermediate server (S) with the capacity to process and transmit at least said control instructions from said remote control means to said microprocessor of the local control means, or vice versa,
the system being characterised in that said food processing and preparation cooking appliance (A1) is a first appliance, and in that the system comprises:
a plurality of food processing and preparation cooking appliances (A1, A2), including said first appliance (A1), each of them with local control means identical or similar to those of the first appliance (A1); and
integrates a database (B) comprised and/or accessible by said intermediate server (S), comprising data relative to said plurality of cooking appliances (A1, A2), indicating their current state and their operational history, and to a plurality of users, including at least respective identification information thereof and the association between users and groups of cooking appliances (A1, A2).

2. A system according to claim 1 characterised in that said communications means in connection with said microprocessor and said communications means of the user computing device (D1) are of wireless technology.

3. A system according to claim 1 characterised in that the transmission of said control instructions is carried out asynchronously or synchronously by means of communications protocols.

4. A system according to claim 1 characterised in that said user computing device (D1) is a first device, and in that the system comprises a plurality of user computing devices (D1, D2, D3), including said first device (D1), with respective communications means in communication with said communications network, each of them being controllable by at least one user and implementing a respective external user interface for the entry of control instructions for controlling one or more food processing and preparation cooking appliances (A1, A2).

5. A system according to claim 1 characterised in that said intermediate server (S) is adapted to make the forwarding of said control instructions to the microprocessor of the required appliance (A1, A2) conditional on:
the result of at least cross-checking at least user's identification information of the user of the user computing device (D1, D2, D3) and of the appliance (A1, A2) he or she wishes to control, or
the result of a verification of the operational state of the appliance and/or of a verification of the existence of some type of error occurred in the appliance.

6. A system according to claim 5 characterised in that said appliances (A1, A2) of said plurality of food processing and preparation cooking appliances are grouped together, each group being associated with one or more users for its control by means of the corresponding forwarding of control instructions to the microprocessors of its local control means.

7. A system according to claim 1 characterised in that each of the users of a plurality of users has access, through at least one of said user computing devices (D1, D2, D3), conditional on the authentication carried out by the intermediate server (S), to at least part of the information recorded in said database (B) and/or received by the intermediate server (S) from the microprocessor of a cooking appliance (A1, A2) associated with said user, including a signal confirming the reception of a control instruction.

8. A system according to claim 4 characterised in that said control instructions include identification information of the appliance (A1, A2) that is to be controlled and/or of the user that is utilising the user computing device (D1, D2, D3).

9. A method for food processing and preparation by cooking comprising:
the control of a cooking appliance (A1) for food processing and preparation by cooking, based on control instructions containing at least some cooking parameters, forwarded to local control means of the appliance (A1), through a communications network, from remote control means including an independent user computing device (D1) separate from said appliance; and
the processing and transmission of said control instructions, through an intermediate server (S), from said remote control means to said microprocessor of the local control means, or vice versa,
the method being characterised by comprising the control of a plurality of cooking appliances (A1, A2) by one or more users, from one or more user computing devices (D1, D2, D3) through the supervision and control of the asynchronous or synchronous forwarding of control instructions, from the respective remote control means, to the local control means of the required appliance (A1, A2), by means of said intermediate server (S) of the communications network.

10. A method according to claims 9 characterised by comprising carrying out, by the intermediate server (S), said forwarding of control instructions to the local control means of the required appliance (A1, A2) conditional on the result of at least cross-checking at least user's identification information of the user of the user computing device (D1) and of the appliance he or she wishes to control, carried out by the intermediate server (S).

11. A method according to claim 9 characterised in that said intermediate server (S) acquires, either actively or passively, at least identification and state information of said appliance or appliances (A1, A2) through the communications means of the local control means and at least user identification information through the communications means of the user computing device or devices (D1, D2, D3).

12. A method according to claim 10 characterised in that said intermediate server (S) acquires, either actively or passively, at least identification and state information of said appliance or appliances (A1, A2) through the communications means of the local control means and at least user identification information through the communications means of the user computing device or devices (D1, D2, D3).

13. A method according to claim 9 characterised in that said intermediate server (S) further transmits multimedia information that will be shown in said user computing device D1, on said user interface thereof, based on operational data acquired by the user of the appliance (A1).

14. A method according to claim 9 characterised by comprising the forwarding, by the intermediate server (S), of a signal confirming the reception of a control instruction to the user computing device (D1, D2, D3) from which a user has requested the control of a cooking appliance (A1, A2).

15. A method according to claim 9 characterised by comprising the transmission of said control instructions in an encrypted way.

16. A computer programme including coded instructions that, when run in a computer, implement the method according to claim 10.
